(19) United States
(12) Patent Application Publication
(10) Pub. No.: US 2009/0028169 A1
(43) Pub. Date: Jan. 29, 2009

(54) METHOD AND DEVICE FOR ROUTING MESH NETWORK TRAFFIC

(75) Inventors: Christopher L. Bear, Marietta, GA (US); Keith J. Goldberg, Casselberry, FL (US)

Correspondence Address: MOTOROLA, INC, 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/829,476

(22) Filed: Jul. 27, 2007

(51) Int. Cl. H04L 12/28

(52) U.S. Cl. 370/406

(57) ABSTRACT

A method and device for routing mesh network traffic from a mesh access point to a non-mesh network as provided improves network efficiency. According to one aspect, the method includes identifying a data flow in the mesh network traffic. A priority of the data flow is then determined. A preferred mesh gateway is then selected from a plurality of mesh gateways based on the priority of the data flow and preference information of the plurality of mesh gateways, where the plurality of mesh gateways provide routes to the non-meshed network. The data flow is then routed to the preferred mesh gateway, wherein the preferred mesh gateway routes the data flow to the non-mesh network.

### FIELD OF THE INVENTION

The present invention relates generally to routing data in wireless networks, and in particular to routing mesh network traffic from a mesh access point to a non-mesh network.

### BACKGROUND

Mesh network technology enables wireless devices to communicate with peers by relaying network data packets through a series of wireless intermediate nodes. The intermediate nodes can be fixed elements of a network infrastructure, or mobile wireless stations that are capable of routing or relaying data packets between neighboring network nodes. A gateway that functions as a bridge between a mesh network and a non-mesh network, such as a backbone network, is called a mesh gateway or an Intelligent Access Point (IAP). A wireless intermediate node, also referred to as a wireless router or a mesh access point, can act as a router, a bridge, or a repeater to relay data packets between neighboring network nodes that are in communication with the wireless intermediate node. Thus, wireless intermediate nodes can extend a communication range of an IAP by relaying data packets between neighboring network nodes.

A mesh network can comprise one or more mesh gateways. The mesh gateways can provide wireless mesh networking by establishing wireless backhaul connections, also referred to as wireless distribution systems (WDSs). This type of mesh networking is referred to as wireless backhaul meshing or infrastructure meshing. Alternatively, a mesh network can comprise mobile wireless stations that act as intermediate nodes by relaying data between nearby mobile stations. This type of mesh networking is referred to as client meshing or ad-hoc networking. A combination of both type of mesh networking also can be used.

A large scale wireless mesh network utilizing low-powered, short-range, high-data rate radios can thus provide long range wireless networking. Advantages of such wireless mesh networking include low interference and large scale wireless coverage that requires significantly less infrastructure than a cellular network. For example, wireless mesh networking can provide ubiquitous Internet access if a mesh gateway participating in the mesh networking is connected the Internet.

However, in mesh networks that manage a lot of data traffic, traffic congestion can occur at a mesh gateway connected to a backbone network such as the Internet or a public switched telephone network (PSTN). That is because each node in a mesh network is generally associated with only a single mesh gateway. Thus, network traffic queued at a mesh gateway can sometimes exceed a capacity of a backhaul link of the mesh gateway, even if another mesh gateway in the same mesh network still has available capacity to route network traffic over another backhaul link.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a schematic diagram illustrating a mesh network, according to some embodiments of the present invention.

FIG. 2 is a block diagram illustrating a mesh routing header of a data packet, according to some embodiments of the present invention.

FIG. 3 is a block diagram illustrating a HELLO message, according to some embodiments of the present invention.

FIG. 4 is a general flow diagram illustrating a method for routing mesh network traffic from a mesh access point to a non-mesh network, according to some embodiments of the present invention.

FIG. 5 is a block diagram illustrating components of a mesh access point, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to routing mesh network traffic from a mesh access point to a non-mesh network. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of routing meshed network traffic from a mesh access point to a non-mesh network as described herein. The non-processor circuits may include, but are not limited to, a radio receiver, a radio transmitter, signal drivers, clock circuits, power source circuits, and user input devices. As such, these functions may be interpreted as steps of a method for routing mesh network traffic from a mesh access point to a non-mesh network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Any embodiment described herein is not necessarily to be construed as preferred or advantageous over other embodiments. All of the embodiments described in this Detailed Description are illustratively provided to enable persons skilled in the art to make or use the invention and not to limit the scope of the invention which is defined by the claims.

According to one aspect, some embodiments of the present invention define a method for routing mesh network traffic from a mesh access point to a non-mesh network. The method includes identifying a data flow in the meshed network traffic. A priority of the data flow is then determined. Next, a preferred mesh gateway is selected from a plurality of mesh gateways based on the priority of the data flow and preference information of the plurality of mesh gateways, where the plurality of mesh gateways provides routes to the non-mesh network. The data flow is then routed to the preferred mesh gateway, whereby the preferred mesh gateway routes the data flow to the non-mesh network.

Some embodiments of the present invention thus enable multiple mesh gateways to share mesh network traffic communicated between nodes in a mesh network and nodes in a non-mesh network. The sharing of mesh network traffic improves network efficiency by increasing overall data throughput between a node in a mesh network and a non-mesh network, which data throughput could be otherwise limited to a single mesh gateway associated with the node. Furthermore, routing a data flow based on a priority of the data flow and preference information of mesh gateways enables a mesh network to provide improved Quality of Service (QoS).

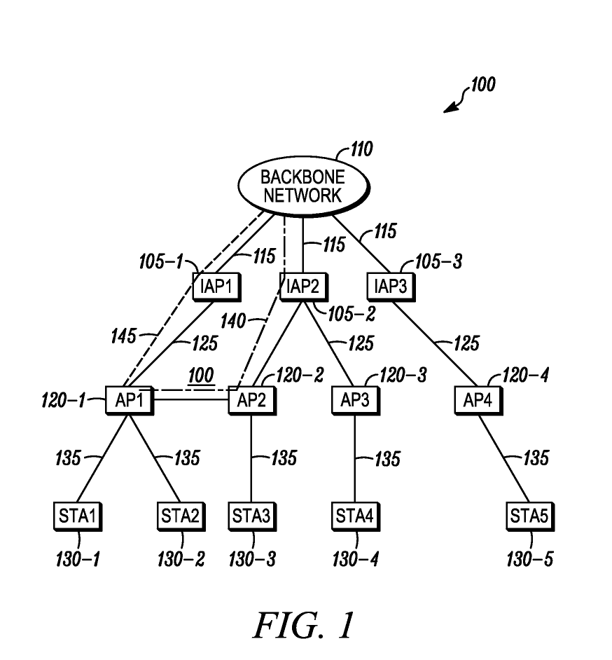

Referring to FIG. 1, a schematic diagram illustrates a mesh network 100, according to some embodiments of the present invention. The mesh network 100 comprises a plurality of Intelligent Access Point (IAP) nodes 105-n (i.e., IAP nodes 105-1 to 105-3) labeled IAP1 through IAP3 that function as mesh gateways. Each IAP node 105-n is connected to a backbone network 110 via a corresponding backbone link 115 and connected to one or more mesh access points 120-n (i.e., mesh access points 120-1 to 120-4) via corresponding wireless links 125. Each mesh access point 120-n functions as an intermediate node routing mesh network traffic for neighboring nodes. Each mesh access point 120-n typically provides one or more sources of audio, video and/or data information. The mesh access point 120-n may be, for example, a cellular base station or other wireless access point. The backbone network 110 can be a non-mesh network, such as the Internet or a wired Local Area Network (LAN). Each mesh access point 120-n is also connected to one or more wireless nodes 130-n (i.e., wireless nodes 130-1 to 130-5, also referred to as wireless stations (STAs) or wireless devices), via corresponding wireless links 135. The wireless nodes 130-1 to 130-5 can generally be wireless devices capable of receiving packetized audio, video and/or data information. Each wireless node 130-n can function as a producer or a consumer of mesh network traffic.

As known by those skilled in the art, each wireless node in a mesh network is normally associated with a single mesh gateway. For example, the wireless nodes 130-1 and 130-2 can be associated with the IAP1 node 105-1; the wireless nodes 130-3 and 130-4 can be associated with the IAP2 node 105-2; and the wireless node 130-5 can be associated with the IAP3 node 105-3. However, for cost and feasibility reasons, some of the backbone links 115 may have a limited bandwidth that may be exceeded under certain network conditions. For example, when all mesh network traffic received from the wireless nodes 130-1 and 130-2 are forwarded to the IAP1 node 105-1, the aggregated mesh network traffic at the IAP1 node 105-1 can exceed a capacity of the backbone link 115 of the IAP1 node 105-1. One method of overcoming this problem is to distribute some of the mesh network traffic to other available IAPs, for example, to the IAP2 node 105-2.

However, routing certain types of data packets received from the wireless nodes 130-1 and 130-2 to the IAP2 node 105-2, rather than to the associated mesh gateway (i.e., the IAP1 node 105-1), can be undesirable. For example, voice data packets are sensitive to latency, and thus routing voice data packets to the IAP2 node 105-2 via a first route 140 can be undesirable. That is because the first route 140 requires more hops to reach the backbone network 110 than an available, and more direct, second route 145. Each additional hop can introduce an additional delay, which means that routing certain types of data packets to an alternate mesh gateway can decrease Quality of Service (QoS) for some data packets. As described in detail below, some embodiments of the present invention enable a mesh access point to group data packets into data flows, and then distribute data flows across a plurality of mesh gateways based on priorities of data flows and preference information of mesh gateways.

According to some embodiments of the present invention, consider that the mesh access point 120-1 receives mesh network traffic in the form of data packets, also referred to as data frames, from the wireless nodes 130-1 and 130-2. The mesh access point 120-1 then groups a certain type of data packets in the mesh network traffic into a data flow. For example, a data flow can be identified by identifying data packets having the following properties: identical source addresses and identical destination addresses; identical source addresses, identical destination addresses, and identical priority values; or identical source addresses, identical destination addresses, and identical flow identities.

To provide priority based routing, the mesh access point 120-1 can then determine a priority of the identified data flow. The priority of the data flow can be determined in various ways, such as by priority values of data packets in the data flow. Alternatively, the priority of the data flow can be determined by types of data packets in the data flow, such as a voice type or a data type. For example, a mesh routing header of a data packet in the data flow can provide a priority value and/or a type of the data packet. As known by those skilled in the art, a Type of Service Differentiated Services Codepoint (ToS-DSCP) value contained in a mesh routing header of a data packet can be used to indicate service parameters, a priority type, and Quality of Service for a data packet. Generally, a first set of data packets in a data flow can be used to determine a priority of the data flow.

The priority of the identified data flow also can be determined by a flow type or a flow identity of the data flow. For example, a flow type of the data flow can be identified from a protocol identity (ID) field or a ToS-DSCP field in a mesh routing header of an initial data packet of the data flow. For instance, a flow type can be defined by a priority type in a ToS field, which can contain a value of “Routine”, “Priority”, or “Immediate”. A ToS-DSCP field of a data packet in a data flow can also provide service parameters, such as a latency factor, a reliability factor, and a bandwidth factor. A flow identity of the data flow can be obtained, for example, from a mesh routing header of a data packet in the data flow.

After a data flow is identified and a priority of the data flow is determined, the mesh access point 120-1 can select a preferred IAP node 105-n for the data flow based on the priority of the data flow and preference information of the IAP nodes 105-n. The mesh access point 120-1 then can route the data flow to the preferred IAP node 105-n, which in turn can route the data flow to the backbone network 110.

According to some embodiments of the present invention, preference information of one or more mesh gateways are determined by one or more of a reliability, bandwidth, latency, or available bandwidth of a backhaul link of each mesh gateway in the plurality of the mesh gateways to a non-mesh network. For example, the mesh access point 120-1 can obtain preference information of the IAP nodes 105-n via HELLO messages received from neighboring nodes, such as the IAP1 node 105-1 and the mesh access point 120-2. The mesh access point 120-1 can then use the preference information to maintain routes to the IAP nodes 105-n.

According to further embodiments, after a priority of a data flow is determined, the mesh access point 120-1 can generate route path metrics of the IAP nodes 105-n based on the priority of the data flow and preference information of the IAP nodes 105-n. The priority of the data flow may specify a flow type and service parameters, such as a latency factor, a reliability factor, and a bandwidth factor. The preference information of the IAP nodes 105-n can, for example, be obtained from HELLO messages received from neighboring nodes. The preference information of the IAP nodes 105-n can comprise metrics of the IAP nodes 105-n and flow weights, where each flow weight can comprise a latency factor weight, a reliability factor weight, and a bandwidth factor weight. The route path metrics then can be used to select one of the IAP nodes 105-n as a preferred mesh gateway. For example, consider that a priority type of a data flow is identified from a ToS-DSCP field of a mesh routing header of a data packet, and the priority type is associated with a flow type identity, ‘id’, that defines a flow type. A route path metric of the IAP node 105-1 then can be obtained for the flow type according to the following equation:

MetricValue₁=RouteMetric₁×(w_{id,l}×fₗ+w_{id,r}×fᵣ+w_{id,b}×f_{b}) (Eq. 1)

where MetricValue₁ is the route path metric of a route path to the IAP node 105-1 for the flow type of the data flow, RouteMetric₁ is a routing metric of the route path, fₗ is a latency factor of the flow type, fᵣ is a reliability factor of the flow type, f_{b} is a bandwidth factor of the flow type, and w_{id,l}, w_{id,r}, and w_{id,b} are, respectively, a latency factor weight value, a reliability factor weight value, and a bandwidth factor weight value for the flow type.

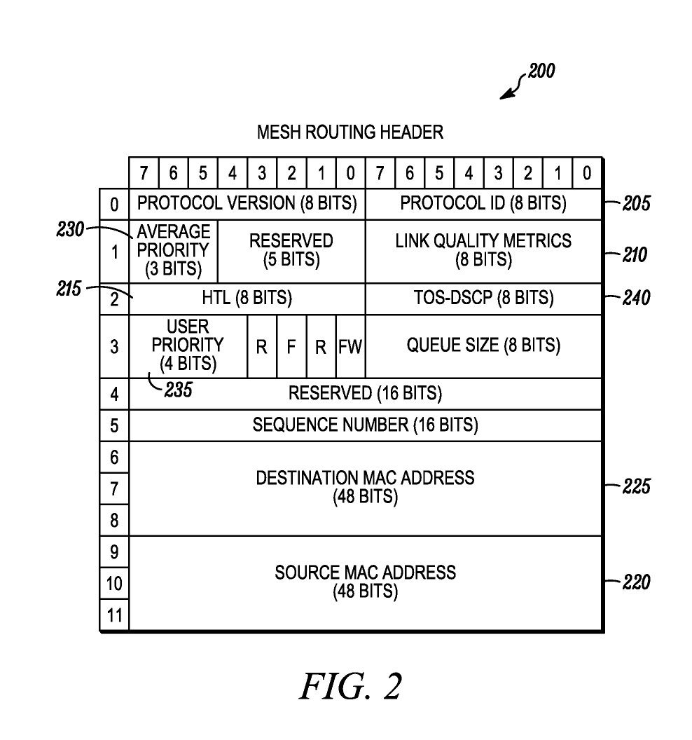

Referring to FIG. 2, a block diagram illustrates a mesh routing header 200 of a data packet, according to some embodiments of the present invention. The mesh routing header 200 comprises a plurality of fields including the following: a protocol ID field 205 that indicates a type of data present in the data packet; a link quality metrics field 210 that indicates a link quality from a view of a sending node of the data packet; a hop-to-live (HTL) counter field 215 that identifies a number of further hops the data packet can travel; a source address field 220 that identifies an address of a source node from which the data packet is originated; a destination address field 225 that identifies an address of a destination address to which the data packet needs to be routed; and priority fields, such as an average priority field 230, a user priority field 235, and a Type of Service Differentiated Services Codepoint (ToS-DSCP) field 240. The average priority field can be used to indicate an average priority level of data packets in a routing queue managed by a receiving node, such as the mesh access points 120-n and the IAP nodes 105-n in the mesh network 100.

Contents of the mesh routing header 200 can be used for routing and traffic prioritization. For example, a route of a data packet can be defined by a pair (source address, destination address), a first type of a 3-tuple (source address, destination address, priority), or a second type of a 3-tuple (source address, destination address, flow identity). Thus, a data flow can have an associated route, as the data flow can comprise data packets having, for example, identical source addresses, destination addresses, and priority values, which can be used to define the associated route. Mesh access points, such as the mesh access point 120-1, also can use priority fields, such as the ToS-DSCP field 240, to determine a priority of a data flow.

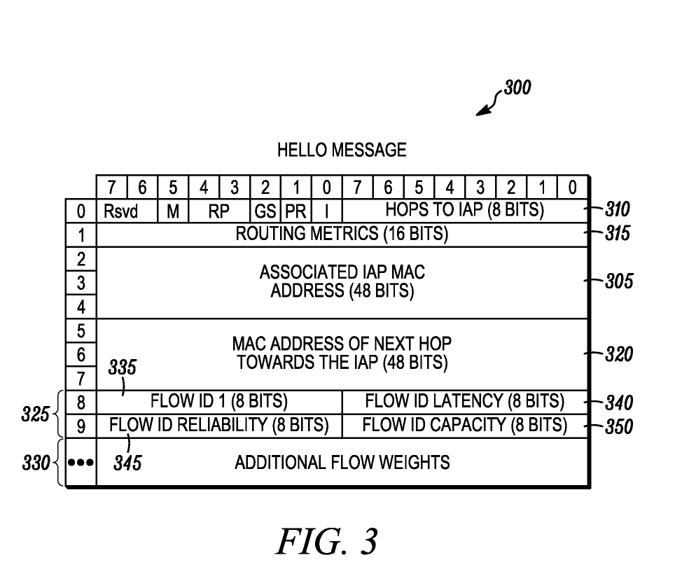

Referring to FIG. 3, a block diagram illustrates a HELLO message 300, according to some embodiments of the present invention. The HELLO message 300 comprises a plurality of fields including the following: an associated IAP Media Access Control (MAC) address field 305 that identifies an IAP, with which a sending node of the HELLO message 300 is associated; a hops-to-IAP field 310 that identifies a number of hops to the associated IAP from a sending node; a routing metrics field 315 that identifies routing metrics to the associated IAP; a next-hop MAC address field 320 that identifies a MAC address of a next hop towards the IAP from the sending node; and one or more flow weight sections 325, 330.

The flow weight sections 325, 330 can provide preference information of the associated IAP and/or a route to the associated IAP for various flow types. For example, the flow weight section 325 can comprise a plurality of fields including the following: a flow type ID field 335 that identifies a flow type; a flow ID latency field 340; a flow ID reliability field 345; and a flow ID capacity field 350 that identifies a latency degree, a reliability, and a bandwidth of a backbone link of the associated IAP, or a route to the associated IAP, respectively. Also, a lack of a flow weight section 325, 330 for a flow type can be used to indicate that the associated IAP or a route to the associated IAP does not support the flow type. For example, advertising only voice flows can indicate that an IAP can backhaul only voice traffic.

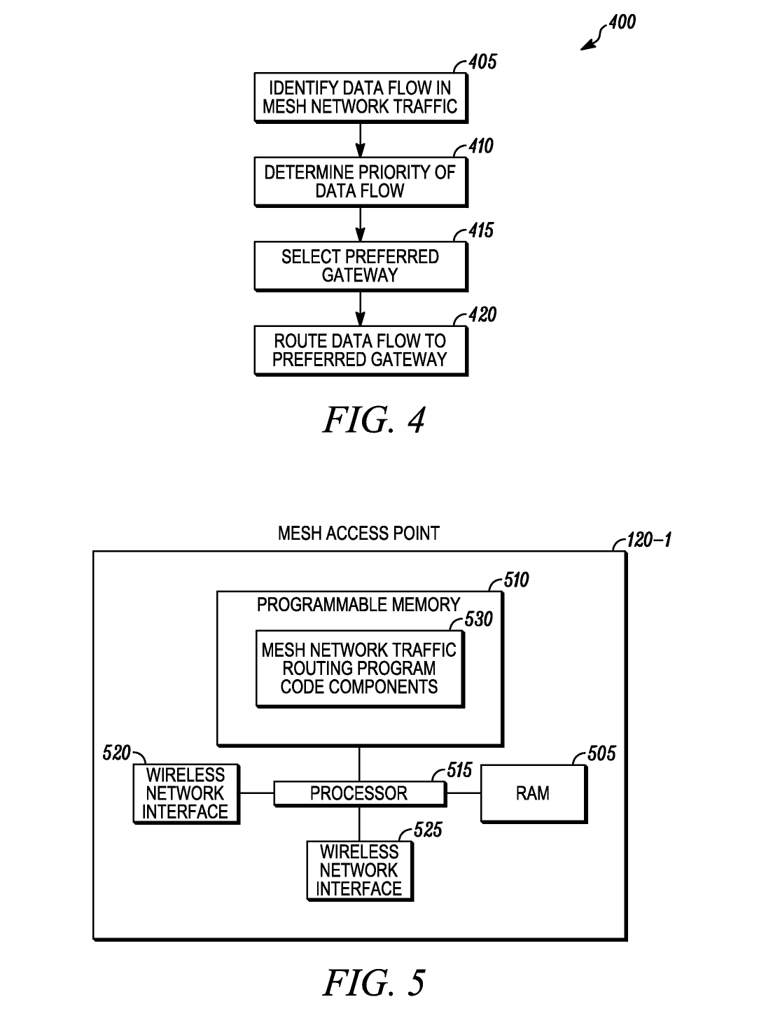

Referring to FIG. 4, a general flow diagram illustrates a method 400 for routing mesh network traffic from a mesh access point to a non-mesh network, according to some embodiments of the present invention. At step 405, a data flow in the mesh network traffic is identified. For example, the mesh access point 120-1 in the mesh network 100 can identify a data flow in mesh network traffic received from the wireless nodes 130-1 and 130-2 by identifying data packets having identical source addresses and identical destination addresses.

At step 410, a priority of the data flow is determined. For example, the mesh access point 120-1 can use a ToS-DSCP field value of a data packet in a data flow received from the wireless node 130-1 to determine a priority of the data flow, which ToS-DSCP field value can include a flow type and service parameters, such as a latency factor value of the data flow.

At step 415, a preferred mesh gateway is selected from a plurality of mesh gateways based on the priority of the data flow and preference information of the plurality of mesh gateways, where the plurality of mesh gateways provide routes to the non-mesh network. For example, a priority of a data flow and preference information of the IAP nodes 105-n can be used to determine a flow type of the data flow and obtain route path metrics of the IAP nodes 105-n for the data flow. The mesh access point 120-1 then can use the route path metrics of the IAP nodes 105-n to select a preferred IAP for the data flow.

At step 420, the data flow is routed to the preferred mesh gateway, where the preferred mesh gateway routes the data flow to the non-mesh network. For example, the mesh access point 120-1 can select the IAP2 node 105-2 as a preferred IAP and route a data flow to the IAP2 node 105-2 via the first route 140. The IAP2 node 105-2 then can route the data flow to the backbone network 110.

Referring to FIG. 5, a block diagram illustrates components of the mesh access point 120-1, according to some embodiments of the present invention. The mesh access point 120-1 comprises a random access memory (RAM) 505 and a programmable memory 510 that are coupled to a processor 515. The processor 515 also has ports for coupling to wireless network interfaces 520, 525. The wireless network interfaces 520, 525 can be used to enable the mesh access point 120-1 to communicate with neighboring network nodes in the mesh network 100. For example, the mesh access point 120-1 can communicate with the IAP1 node 105-1 using the wireless network interface 520, and with the wireless nodes 130-1 and 130-2 using the wireless network interface 525, to receive and send data packets and to route the data packets.

The programmable memory 510 can store operating code (OC) for the processor 515 and code for performing functions associated with a mesh access point. For example, the programmable memory 510 can comprise mesh network traffic routing services computer readable program code components 530 configured to cause execution of a method for routing mesh network traffic as described herein.

Advantages of the present invention thus include enabling a node in a mesh network to distribute mesh network traffic across a plurality of mesh gateways based on priorities of data flows and preference information of the mesh gateways, which can improve network efficiency by increasing overall data throughput between a node in a mesh network and a non-mesh network. Data throughput between a node in a mesh network and a non-mesh network is normally limited by a bandwidth of a backbone link of a mesh gateway that is associated with the node. Also, routing data packets to alternate routes without considering conditions of the routes and/or a priority of the data packets can introduce undesirable side effects, such as a failure to provide an adequate Quality of Service (QoS) for certain types of data packets. Thus, some embodiments of the present invention enable a node to identify a data flow in mesh network traffic and to determine a priority of the data flow, where the priority is then used to select a preferred mesh gateway for the data flow from a plurality of available mesh gateways using preference information concerning the mesh gateways. Gateways that are not appropriate for a certain data type then can be avoided. For example, a gateway having a large latency factor on a backhaul link can be avoided when routing voice data packets. Therefore both traffic prioritization and load distribution can be performed efficiently, and a mesh network traffic distribution can be provided across a plurality of mesh gateways without sacrificing a QoS of a data flow.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

We claim:

1. A method for routing mesh network traffic from a mesh access point to a non-mesh network, the method comprising:
identifying a data flow in the mesh network traffic;
determining a priority of the data flow;
selecting a preferred mesh gateway from a plurality of mesh gateways based on the priority of the data flow and preference information of the plurality of mesh gateways, wherein the plurality of mesh gateways provide routes to the non-mesh network; and
routing the data flow to the preferred mesh gateway, wherein the preferred mesh gateway routes the data flow to the non-mesh network.

2. The method of claim 1, wherein the priority of the data flow is determined by priority values of data packets in the data flow.

3. The method of claim 1, wherein the priority of the data flow is determined by types of data packets in the data flow.

4. The method of claim 1, wherein the priority of the data flow is determined by a flow type or a flow identity of the data flow.

5. There method of claim 1, wherein the preference information of the plurality of mesh gateways are determined by one or more of a reliability, bandwidth, latency, or available bandwidth of a backhaul link of each mesh gateway in the plurality of the mesh gateways to the non-mesh network.

6. The method of claim 1, wherein the data flow is identified by identifying data packets having identical source addresses and identical destination addresses.

7. The method of claim 1, wherein the data flow is identified by identifying data packets having identical source addresses, identical destination addresses, and identical priority values.

8. The method of claim 1, wherein the data flow is identified by identifying data packets having identical source addresses, identical destination addresses, and identical flow identities.

9. The method of claim 1, wherein the mesh access point maintains routes to the plurality of mesh gateways.

10. The method of claim 1, wherein the mesh access point receives preference information of mesh gateways in the plurality of mesh gateways via HELLO messages.

11. The method of claim 10, wherein the HELLO messages comprise one or more of a latency factor weight value, a reliability factor weight value, and a bandwidth factor weight value for a flow type.

12. The method of claim 1, wherein the preferred mesh gateway is selected based on route path metrics of route paths to the non-mesh network via the plurality of mesh gateways.

13. The method of claim 12, wherein the route path metrics of route paths to the non-mesh network via the plurality of mesh gateways are calculated according to the following equation:
MetricValueₙ=RouteMetricₙ×(w_{id,l}×fₗ+w_{id,r}×fᵣ+w_{id,b}×f_{b}),
where MetricValueₙ is a route path metric of a route path to an n-th mesh gateway in the plurality of mesh gateways for a flow type of the data flow, RouteMetricₙ is a route metric of a route path, fₗ is a latency factor of the flow type, fᵣ is a reliability factor of the flow type, f_{b} is a bandwidth factor of the flow type, id is a flow type identity, and w_{id,l}, w_{id,r}, and w_{id,b} are, respectively, a latency factor weight value, a reliability factor weight value, and a bandwidth factor weight value for the flow type.

14. A mesh access point for routing mesh network traffic to a non-mesh network, comprising:
computer readable program code components configured to cause identifying a data flow in the mesh network traffic;
computer readable program code components configured to cause determining a priority of the data flow;
computer readable program code components configured to cause selecting a preferred mesh gateway from a plurality of mesh gateways based on the priority of the data flow and preference information of the plurality of mesh gateways, wherein the plurality of mesh gateways provide routes to the non-mesh network; and
computer readable program code components configured to cause routing the data flow to the preferred mesh gateway, wherein the preferred mesh gateway routes the data flow to the non-mesh network.

15. The mesh access point of claim 14, wherein the priority of the data flow is determined by priority values of data packets in the data flow.

16. The mesh access point of claim 14, wherein the priority of the data flow is determined by types of data packets in the data flow.

17. The mesh access point of claim 14, wherein the priority of the data flow is determined by a flow type or a flow identity of the data flow.

18. The mesh access point of claim 14, wherein the preference information of the plurality of mesh gateways are determined by one or more of a reliability, bandwidth, latency, or available bandwidth of a backhaul link of each mesh gateway in the plurality of mesh gateways to the non-mesh network.

19. The mesh access point of claim 14, wherein the data flow is identified by identifying data packets having identical source addresses and identical destination addresses.

20. A mesh access point for routing mesh network traffic to a non-mesh network, comprising:
means for identifying a data flow in the mesh network traffic;
means for determining a priority of the data flow;
means for selecting a preferred mesh gateway from a plurality of mesh gateways based on the priority of the data flow and preference information of the plurality of mesh gateways, wherein the plurality of mesh gateways provide routes to the non-mesh network; and
means for routing the data flow to the preferred mesh gateway, wherein the preferred mesh gateway routes the data flow to the non-mesh network.
